(19) United States
(12) Patent Application Publication
(10) Pub. No.: US 2009/0203395 A1
(43) Pub. Date: Aug. 13, 2009

(54) AMPLITUDE MODULATION RADIO TRANSMISSION WITH EXTENDED BANDWIDTH

(75) Inventor: Hans Peter KORNER, Lund (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/028,065

(22) Filed: Feb. 8, 2008

(51) Int. Cl. H04M 1/00; H04B 1/06

(52) U.S. Cl. 455/550.1; 455/130

(57) ABSTRACT

A system provides a high-fidelity audio signal from an amplitude modulation (AM) transmission that includes an audio signal. The system receives, with a radio device, the amplitude modulation (AM) transmission, and retrieves, with the radio device, the audio signal from the amplitude modulation (AM) transmission. The system also extends, with the radio device, a high-frequency bandwidth of the audio signal to provide the high-fidelity audio signal.

### TECHNICAL FIELD

The present invention relates to the field of amplitude modulated radio transmission. Embodiments of the invention relate to amplitude modulated radio transmission with an extended audio bandwidth.

### BACKGROUND

Amplitude modulation (AM) has been known since the beginning of radio transmissions. In fact, amplitude modulation was one of the first modulation techniques to be used in the earlier years of radio communication and it has been frequently used since then.

Amplitude modulation is a technique often used in electronic communication for transmitting information via a radio carrier wave. Generally, amplitude modulation works by varying an amplitude of a transmitted continuous wave radio signal (i.e., a carrier wave) in relation to information being sent by the carrier wave. There are several forms of amplitude modulation, such as, for example, double-sideband full-carrier, single-sideband reduced carrier, single-sideband full carrier, single-sideband suppressed-carrier, independent-sideband emission and vestigial-sideband, etc.

AM radio is communicated on several frequency bands. The allocation of these bands is governed by regulations issued by the International Telecommunication Union (ITU). On a national level, allocation of AM frequency bands is typically governed by each country's telecommunications administration, subject to international agreements. An example is the Federal Communications Commission (FCC) in the U.S.A.

The most heavily used band for commercial AM communication is the Medium Wave band (MW-band), extending approximately between 500 kilohertz (kHz) and 1600 kHz. This is the “AM radio” that most people are familiar with. Medium Wave AM radio stations are typically separated by 10 kHz and have two sidebands of ±5 kHz, or are typically separated by 9 kHz and have two sidebands of ±4.5 kHz. Both frequency channel allocations provide reasonably audio quality for voice, but are insufficient for the high-fidelity broadcasts that are commonly provided by frequency modulation (FM) (e.g., FM provided on the Very High Frequency band (VHF-band)).

Traditional AM communication may also occur on the long wave band (LW-band, approximately 150 kHz to 300 kHz), and/or on the short wave band (SW-band, approximately 2.3 megahertz (MHz) to 26 MHz). Like frequency channels in the MW-band, frequency channels in the LW-band and the SW-band are narrowly allocated giving insufficient capacity for high-fidelity audio broadcasts. In general, an AM transmission with a narrow frequency channel allocation may have a frequency channel allocation that is less than 5 kHz, 10 kHz, 15 kHz, 20 kHz, 25 kHz, 30 kHz, 35 kHz, 40, kHz, 45 kHz, 50 kHz, 55 kHz, 60 kHz, 65 kHz, 70 kHz, 75 kHz, 80 kHz, 85 kHz, 90 kHz, 95 kHz, 100 kHz, 125 kHz, 150 kHz, 175 kHz, 200 kHz, 250 kHz, 300 kHz, 350 kHz, 400 kHz, 450 kHz, or 500 kHz.

However, communications on frequency bands that are typically used for AM transmissions (i.e., the LW-band, MW-band, and/or SW-band) have the advantageous properties of following a curvature of the earth (e.g., a groundwave) and reflecting from the ionosphere (e.g., a skywave). These properties make the AM frequency bands suited for both local and continent-wide service. In contrast, transmissions performed on higher frequency bands neither follow the earth's curvature nor reflect from the ionosphere. In other words, transmissions, such as frequency modulated (FM) transmissions on the VHF-band, are inferior to AM transmissions in this respect. Another advantage of AM transmissions compared to FM transmissions is that that AM signals can be encoded and particularly decoded using very simple equipment. Thus, compared to FM transmissions, there are several advantages of AM communication that can be successfully utilized (e.g., in long range applications and/or low-cost applications).

### SUMMARY

Embodiments described herein may provide an AM radio transmission (e.g., which includes AM radio broadcasts) that includes the advantages of traditional AM transmissions and provides high-fidelity audio within the narrow frequency channels that are available for such AM transmissions. In addition, embodiments described herein may relate to a portable device capable of receiving AM radio transmissions so as to provide high-fidelity audio to a user of the device. Some embodiments described herein may relate to a portable communication device (e.g., a cellular phone) capable of receiving AM radio transmissions so as to provide high-fidelity audio to a user of the device. In other embodiments, however, one or more stationary devices may be used instead of a portable device.

According to one embodiment, a method may provide a high-fidelity audio signal from an amplitude modulation (AM) transmission that may include an audio signal. The method may include receiving, with a radio device, the amplitude modulation (AM) transmission, retrieving, with the radio device, the audio signal from the amplitude modulation (AM) transmission, and extending, with the radio device, a high-frequency bandwidth of the audio signal to provide the high-fidelity audio signal.

Additionally, the amplitude modulation (AM) transmission may include a narrow frequency channel allocation.

Additionally, the method may include extending the high-frequency bandwidth of the audio signal using a blind bandwidth extension operating on the audio signal.

Additionally, the amplitude modulation (AM) transmission may include the audio signal and side information about missing high frequency components of the audio signal, and the method may further include retrieving the side information from the amplitude modulation (AM) transmission, and extending the high-frequency bandwidth of the audio signal using a non-blind bandwidth extension that operates on the audio signal based on the side information.

Additionally, the radio device may include a portable radio device.

Additionally, the portable radio device may include a cellular phone.

According to another embodiment, a radio device may include amplitude modulation (AM) circuitry that receives an amplitude modulation (AM) transmission that includes an audio signal, and retrieves the audio signal from the amplitude modulation (AM) transmission. The radio device may also include a high-frequency bandwidth-extension control that extends a high-frequency bandwidth of the audio signal.

Additionally, the amplitude modulation (AM) transmission may include a narrow frequency channel allocation.

Additionally, the high-frequency bandwidth-extension control may extend the high-frequency bandwidth of the audio signal using a blind bandwidth extension operating on the audio signal.

Additionally, the amplitude modulation (AM) transmission may include the audio signal and side information about missing high frequency components of the audio signal. The high-frequency bandwidth-extension control may retrieve the side information, and may extend the high-frequency bandwidth of the audio signal using a non-blind bandwidth extension that operates on the audio signal based on the side information.

Additionally, the radio device may include a portable radio device.

Additionally, the portable radio device may include a cellular phone.

According to still another embodiment, a computer-readable memory device may store computer-executable instructions that include one or more instructions to receive an amplitude modulation (AM) transmission that includes an audio signal, one or more instructions to retrieve the audio signal from the amplitude modulation (AM) transmission, and one or more instructions to extend a high-frequency bandwidth of the audio signal to provide a high-fidelity audio signal.

According to further embodiment, a radio device may include amplitude modulation (AM) circuitry, a high-frequency bandwidth-extension control, and a computer-readable memory device that stores computer-executable instructions that may include one or more instructions to instruct the amplitude modulation (AM) circuitry to receive an amplitude modulation (AM) transmission that includes an audio signal, one or more instructions to instruct the amplitude modulation (AM) circuitry to retrieve the audio signal from the amplitude modulation (AM) transmission, and one or more instructions to instruct the high-frequency bandwidth-extension control to extend a high-frequency bandwidth of the audio signal to provide a high-fidelity audio signal.

### BRIEF DESCRIPTION OF THE DRAWINGS

The accompanying drawings, which are incorporated in and constitute a part of this specification, illustrate one or more embodiments described herein and, together with the description, explain these implementations. In the drawings:

FIG. 1 depicts an exemplary portable communication device;

FIG. 2 illustrates the portable communication device depicted in FIG. 1 communicating with a cellular network and within a range of an amplitude modulation (AM) radio station;

FIG. 3 depicts a schematic block diagram of exemplary components of the portable communication device illustrated in FIG. 1;

FIG. 4 illustrates a flow chart of a process according to embodiments described herein; and

FIG. 5 depicts a computer-readable memory device that may execute the process illustrated in FIG. 4.

### DETAILED DESCRIPTION

Embodiments described herein may provide high-fidelity audio within narrow frequency channels available for amplitude modulation (AM) transmissions. Some embodiments described herein may relate to a portable communication device (e.g., a cellular phone) that receives amplitude modulation (AM) radio transmissions and provides high-fidelity audio to a user of the device. However, embodiments described herein not limited to use with portable communication devices. Rather, embodiments described herein can be applied to any device capable of receiving amplitude modulation (AM) transmissions.

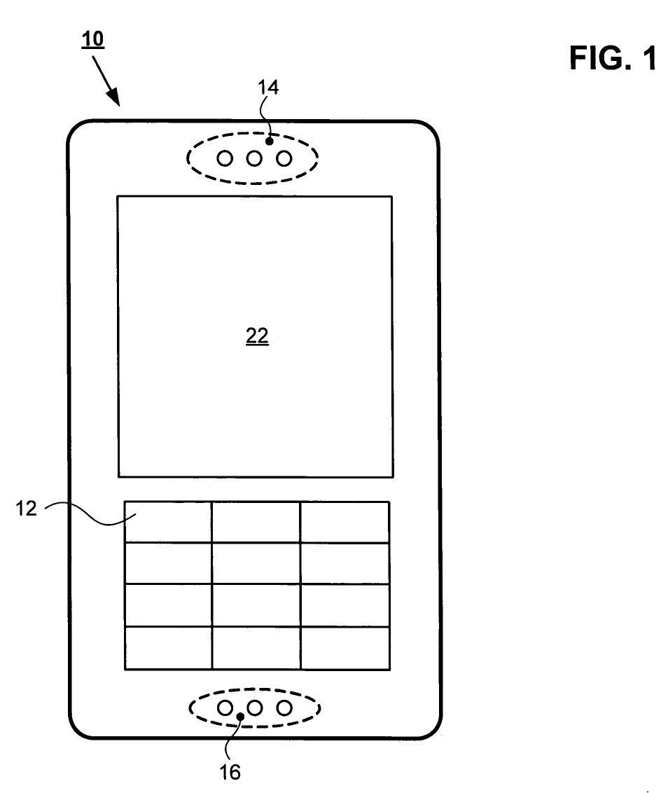

FIG. 1 depicts an exemplary portable communication device 10. In one embodiment, portable communication device 10 may include a mobile cellular telephone that may operate according to 3G technology (e.g., Wideband Code Division Multiple Access (W-CDMA) or CDMA2000), according to 2.5 technology (e.g., General Packet Radio Service (GPRS)), or according to similar technology.

However, embodiments described herein may be implemented in other communication devices, and particularly in other wireless communication devices, such as, for example, communication devices for local wireless communication (e.g., WiFi based on the standard IEEE 802.11) and/or for regional communication (e.g., WiMax based on the standard IEEE 802.16). In other embodiments, portable communication device 10 may include a personal digital assistant (PDA), a palm top computer, a lap top computer, a smartphone, or other suitable portable devices.

As shown in FIG. 1, portable communication device 10 may include a keypad 12, a speaker 14, a microphone 16, and a display 22. Keypad 12 may be used for entering information such as selection of functions and responding to prompts. Speaker 14 may be used for presenting sounds to a user and microphone 16 may be used for receiving audio input from the user. Display 22 may display functions, prompts, etc. to a user of portable communication device 10. In addition, portable communication device 10 may include an antenna arrangement that may communication with other devices (e.g., another cell phone) via a network, and/or may receive amplitude modulation (AM) transmissions. The antenna arrangement may be provided within portable communication device 10, and thus is not shown in FIG. 1.

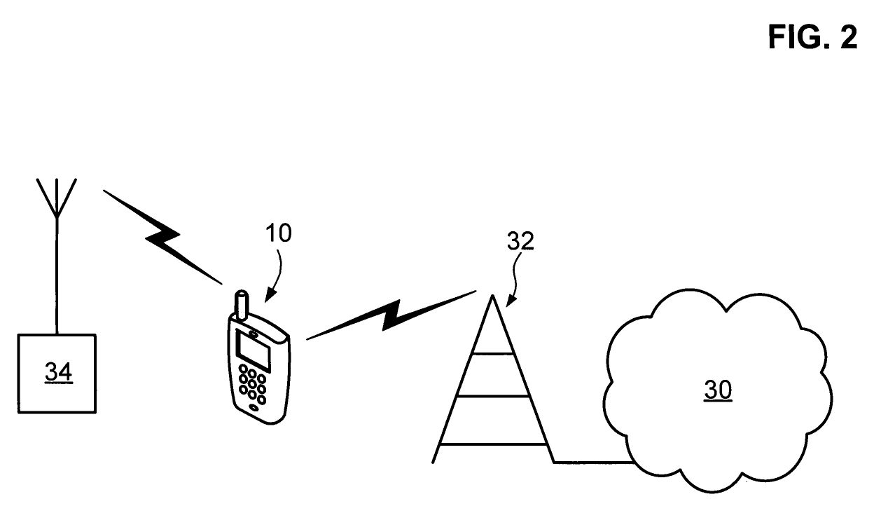

FIG. 2 illustrates portable communication device 10 communicating with a cellular network 30 (e.g., via a base station 32), and within a range of an amplitude modulation (AM) radio station 34. Cellular network 30 may include a 3G network (e.g., a W-CDMA network or another type of 3G network), a GPRS network, 2.5G or 2.75G network, a local network (e.g., a WiFi network), a regional network (e.g., a WiMax network), a Wireless Local Area Network (WLAN), some other wireless network, etc. As further shown in FIG. 2, portable communication device 10 may be in a position that enables it to receive an amplitude modulation (AM) transmission from amplitude modulation (AM) radio station 34. The amplitude modulation (AM) transmission may include an audio signal (e.g., a music piece, a news broadcast, etc.). The term “transmission,” as used herein, is to be broadly construed to include point-to-point transmissions, point-to-multipoint transmissions, broadcasts, etc.

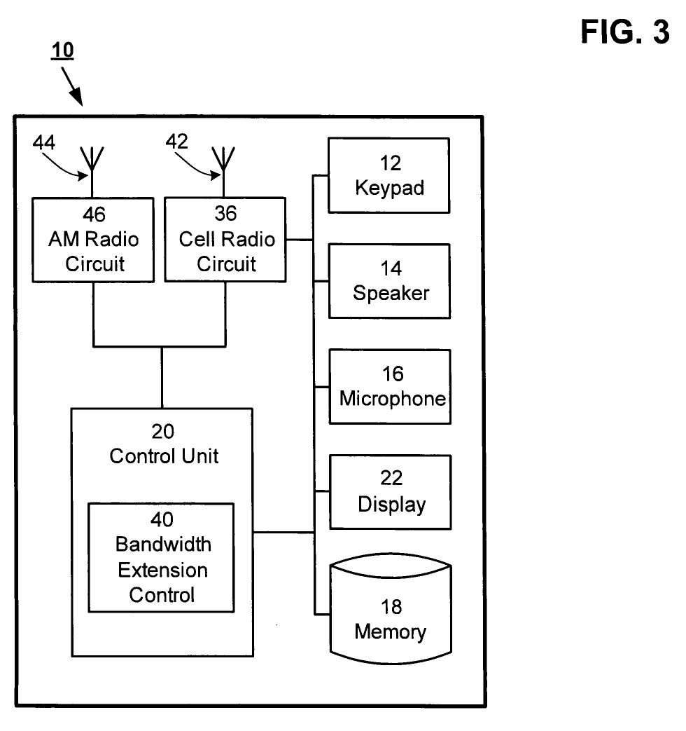

FIG. 3 depicts a schematic block diagram of exemplary components of the portable communication device 10. As illustrated, portable communication device 10 may include keypad 12, speaker 14, microphone 16, a memory arrangement 18 (e.g., a computer-readable memory device), a control unit 20 (e.g., that may include a bandwidth extension control 40), display 22, a first radio circuit 36, a second radio circuit 46, a first antenna 42, and a second antenna 44. Keypad 12, speaker 14, microphone, and display 22 may include the features described above in connection with FIG. 2.

Memory arrangement 18 may provide storage (e.g., for storing computer-executable instructions, such as system files, data files, etc.). In one embodiment, memory arrangement 18 may include a random access memory (RAM), a read-only memory (ROM), and/or another type of memory to store data and instructions that may be used by control unit 20.

Control unit 20 may control operation of portable communication device 10 and its components. In one embodiment, control unit 20 may include a processor, a microprocessor, an application specific integrated circuit (ASIC), a field programmable gate array (FPGA), or the like. Control unit 20 may be implemented via hardware and/or software, and may include one or more hardware units and/or software modules (e.g., one or more processor units provided with or having access to software and hardware than enable performance of functions by portable communication device 10). As shown in FIG. 3, control unit 20 may connect with (e.g., directly or indirectly) keypad 12, speaker 14, microphone 16, memory 18, display 22, first radio unit 36, and second radio unit 46, so that control unit 20 may control and communicate with these components (e.g., via an exchange of information and instructions).

Control unit 20 may include bandwidth-extension control 40. Bandwidth-extension control 40 may be implemented via hardware and/or software, and may include one or more hardware units and/or software modules (e.g., one or more processor units provided with or having access to software and hardware than enable performance of functions by portable communication device 10).

Bandwidth-extension control 40 may perform a bandwidth extension of an audio signal provided by an amplitude modulation (AM) transmission received by portable communication device 10 via second antenna 44 and second amplitude modulation (AM) radio circuit 46 (i.e., received via amplitude modulation (AM)-circuitry of portable communication device 10. In one embodiment, the amplitude modulation (AM)-circuitry may provide a digital signal to control unit 20 and bandwidth-extension control 40. A digital signal may be provided by demodulating the amplitude modulation (AM) transmission received by the amplitude modulation (AM)-circuitry, and by feeding the demodulated signal through an analog-to-digital (A/D) converter (not shown). In one embodiment, the received amplitude modulation (AM)-signal may be fed substantially directly to a high-speed A/D converter without any prior demodulation, and a demodulation may be performed on the digital signal received from the A/D-converter by bandwidth-extension control 40. In other embodiments, an A/D converter may be arranged in second amplitude modulation (AM) radio circuit 46, control unit 20, and/or bandwidth extension control 40.

Bandwidth-extension control 40 may control an amplitude modulation (AM) transmission received from amplitude modulation (AM) radio station 34 via the amplitude modulation (AM) circuitry of the portable communication device 10 so as to extend the bandwidth of an audio signal provided in the amplitude modulation (AM) transmission.

A bandwidth extension may maintain advantages associated with amplitude modulation (AM) communication at existing LW-bands, MW-bands, and SW-bands and may provide a high-fidelity audio signal within narrow frequency channels available for existing amplitude modulation (AM) transmissions.

Moreover, a high-frequency bandwidth extension of an audio signal provided in a received amplitude modulation (AM) transmission may be particularly advantageous in a portable device (e.g., a cell phone) due to the fact that an amplitude modulation (AM)-receiver can be made small, simple, and inexpensively, which may be important in cell phones due to limited physical space and intense price pressure.

There are various bandwidth extension algorithms which may be classified according to their frequency range, but also as either a blind extension operating on a received audio signal (i.e., substantially without any supporting information about “missing” frequency components), or as a non-blind extension that may use a priori information about “missing” frequency components when operating on the received audio signal. Hence, bandwidth extension algorithms may be classified as low frequency, high frequency, blind extension, and/or non-blind extension.

An example of a method that may be used for a blind high-frequency bandwidth extension is described in E. Larsen et al., “Efficient high-frequency bandwidth extension of music and speech” (presented in proceedings of the 112th AES Convention (Munich, Germany)), Audio Eng. Soc. (May 2002). The method may add an extra octave at a high frequency part of the spectrum by using a non-linearity arrangement that operates on the received audio signal to generate the extended octave. The method can be applied to music as well as speech. Another example of a method that can be used for a blind high-frequency bandwidth extension is described in Chi-Min Liu et al., “High frequency Reconstruction for band-limited audio signals,” presented in the proceedings of the 6th International Conference on Digital Audio Effects (DAFX-03), London, UK (Sep. 8-11, 2003). The method may reconstruct lost high-frequency components from the received band-limited audio signal by means of a frequency-domain approach. In other embodiments, different blind high-frequency bandwidth extension methods may be used.

Blind bandwidth extension of an audio signal provided by an amplitude modulation (AM) transmission may include the advantage that existing narrowband amplitude modulation (AM) audio transmissions can be used. In contrast, non-blind bandwidth extension methods may require that the transmission includes additional side information about “missing” high frequency components of the audio signal provided by the transmission. Hence, the information must be extracted before the transmission (e.g., by an encoder at a transmitter), and may be provided in the transmission so as to define at least the basic structure of the “missing” high frequency components. Non-blind bandwidth extension methods may require dedicated amplitude modulation (AM) radio transmitters (i.e., transmitters that differ from existing traditional amplitude modulation (AM) radio transmitters). However, embodiments described herein may include a non-blind bandwidth extension of an audio signal provided by an amplitude modulation (AM) transmission.

An example of a method that can be used for a non-blind high-frequency bandwidth extension is “Spectral Band Replication (SBR)” (see, e.g., Martin Dietz et al., “Spectral Band Replication, a novel approach in audio coding,” presented at the 112th Convention of the Audio Engineering Society in Munich (May 10-13, 2002)). The SBR replicates higher frequency components by transposing up harmonics from lower and mid-frequencies at a receiver (e.g., by means of a decoder at the receiver). Some guidance information for reconstruction of the high-frequency components (e.g., a spectral envelope) may be transmitted as side information in the transmission. In other embodiments, different non-blind high-frequency bandwidth extension methods may be used.

As further shown in FIG. 3, first antenna 42 may connect to first radio circuit 36 (e.g., a cell radio circuit) to enable wireless communication with network 30. Various designs of first antenna 42 and radio circuit 36 are possible (e.g., antennas and radio circuits provided in cell phones). Second antenna 44 may connect to second radio circuit 46 (e.g., an AM radio circuit) to enable reception of amplitude modulation (AM) transmissions from amplitude modulation (AM) radio station 34, as described above. Such amplitude modulation (AM) antennas, amplitude modulation (AM) receivers, and ancillary circuits supporting such amplitude modulation (AM) units may be conventional in design (e.g., a rudimentary amplitude modulation (AM) receiver may be based on a diode detector).

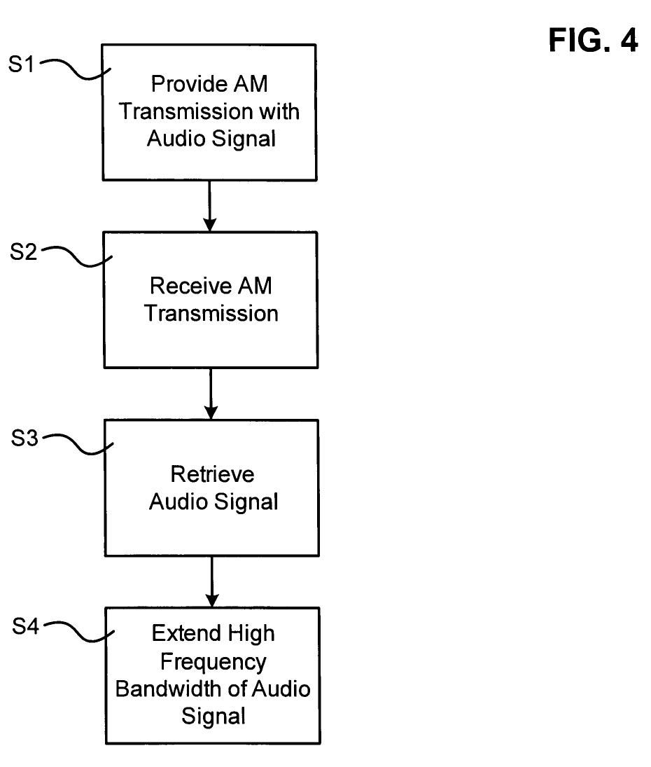

FIG. 4 illustrates a flow chart of a process for providing a high-fidelity audio signal from an audio signal provided in an amplitude modulation (AM) transmission by extending a high-frequency bandwidth of the audio signal. In one embodiment, the process of FIG. 4 of may be performed by bandwidth-extension control 40 of portable communication device 10. In other embodiments, the process of FIG. 4 may be performed by one or more other components of portable communication 10 in addition to or excluding bandwidth-extension control 40. In still other embodiments, one or more portions of the process may be performed by one or more of the devices depicted in FIG. 3.

As shown in FIG. 4, the process may include providing an amplitude modulation (AM) transmission that includes an audio signal (block S1). For example, in implementations described above in connection with FIG. 2, amplitude modulation (AM) radio station 34 may transmit an amplitude modulation (AM) transmission that includes an audio signal.

The process may also include receiving the amplitude modulation (AM) transmission (block S2). For example, in implementations described above in connection with FIG. 3, portable communication device 10 may receive an amplitude modulation (AM) transmission. In one example the amplitude modulation (AM) transmission may received by amplitude modulation (AM)-circuitry (e.g., second antenna 44 and second radio circuit 46) of portable communication device 10.

The process may further include retrieving the audio signal provided by the amplitude modulation (AM) transmission (block S3). For example, in implementations described above in connection with FIG. 3, the amplitude modulation (AM)-circuitry may include a mechanism for demodulating the received amplitude modulation (AM) transmission so to retrieve the audio signal from the amplitude modulation (AM) transmission. In one example, amplitude modulation (AM) radio circuit 46 may include a mechanism (e.g., an A/D converter) for converting the retrieved audio signal into a digital format.

As further shown in FIG. 4, the process may include extending a high-frequency bandwidth of the audio signal (block S4). For example, in implementations described above in connection with FIG. 3, the audio signal may be provided to control unit 20 and to bandwidth-extension control 40. Bandwidth-extension control 40 may perform a high-frequency bandwidth extension of the audio signal via a blind high-frequency bandwidth extension. However, a non-blind high-frequency bandwidth extension may be utilized in certain embodiments described herein, provided that the amplitude modulation (AM) transmission is adapted accordingly (i.e., adapted to include additional side information about high frequency components that may be “missing” in the audio signal).

The bandwidth extended audio signal may then be utilized by a user of portable communication device 10. For example, the bandwidth extended audio signal may be amplified and provided to a speaker (e.g. speaker 14) of portable communication device 10 or to a speaker provided in a headset connected to portable communication device 10.

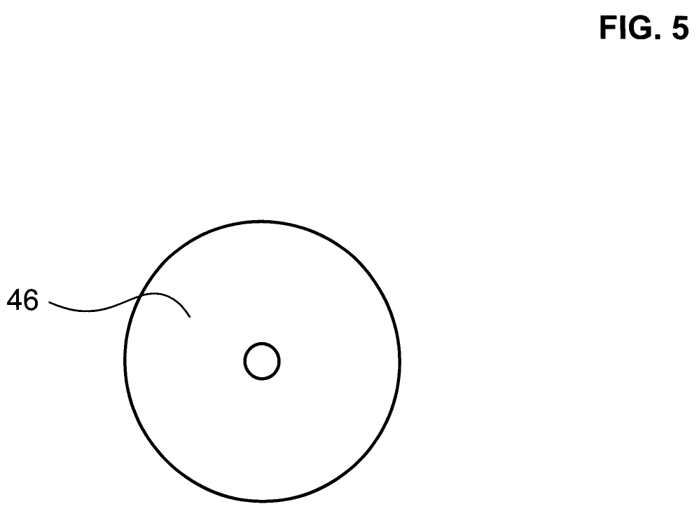

Bandwidth-extension control 40 may perform the process of FIG. 4 via one or more processors with corresponding memory containing software in the form of a program code. However, the program code may also be provided on a computer-readable memory device 46 as depicted in FIG. 5. Computer-readable memory device 46 may include a CD-ROM, a memory stick, an optical disc, etc., which may execute the process of FIG. 4 when loaded into a device (e.g., a computer, a cell phone, etc.) having suitable processing capabilities. The program code may also be downloaded remotely from a server either outside or inside cellular network 30 or be downloaded via a computer to which portable communication device 10 may be temporarily connected.

Embodiments described herein may provide an AM radio transmission (e.g., which includes AM radio broadcasts) that includes the advantages of traditional AM transmissions and provides high-fidelity audio within the narrow frequency channels that are available for such AM transmissions. In addition, embodiments described herein may relate to a portable device capable of receiving AM radio transmissions so as to provide high-fidelity audio to a user of the device. Some embodiments described herein may relate to a portable communication device (e.g., a cellular phone) capable of receiving AM radio transmissions so as to provide high-fidelity audio to a user of the device. In other embodiments, however, one or more stationary devices may be used instead of a portable device.

The foregoing description of embodiments provides illustration and description, but is not intended to be exhaustive or to limit the invention to the precise form disclosed. Modifications and variations are possible in light of the above teachings or may be acquired from practice of the invention.

For example, while a series of blocks has been described with regard to FIG. 4, the order of the blocks may be modified in other implementations. Further, non-dependent blocks may be performed in parallel.

It will be apparent that embodiments, as described herein, may be implemented in many different forms of software, firmware, and hardware in the implementations illustrated in the figures. The actual software code or specialized control hardware used to implement embodiments described herein is not limiting of the invention. Thus, the operation and behavior of the embodiments were described without reference to the specific software code—it being understood that one would be able to design software and control hardware to implement the embodiments based on the description herein.

Further, certain portions of the invention may be implemented as “logic” that performs one or more functions. This logic may include hardware, such as an application specific integrated circuit or a field programmable gate array, software, or a combination of hardware and software.

It should be emphasized that the term “comprises/comprising” when used in the this specification is taken to specify the presence of stated features, integers, steps or components but does not preclude the presence or addition of one or more other features, integers, steps, components or groups thereof.

Even though particular combinations of features are recited in the claims and/or disclosed in the specification, these combinations are not intended to limit the invention. In fact, many of these features may be combined in ways not specifically recited in the claims and/or disclosed in the specification.

No element, block, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method for providing a high-fidelity audio signal from an amplitude modulation (AM) transmission that includes an audio signal, the method comprising:
receiving, with a radio device, the amplitude modulation (AM) transmission;
retrieving, with the radio device, the audio signal from the amplitude modulation (AM) transmission; and
extending, with the radio device, a high-frequency bandwidth of the audio signal to provide the high-fidelity audio signal.

2. The method of claim 1, where the amplitude modulation (AM) transmission includes a narrow frequency channel allocation.

3. The method of claim 1, where extending comprises:
extending the high-frequency bandwidth of the audio signal using a blind bandwidth extension operating on the audio signal.

4. The method of claim 1, where the amplitude modulation (AM) transmission includes the audio signal and side information about missing high frequency components of the audio signal, and the method further comprises:
retrieving the side information from the amplitude modulation (AM) transmission; and
extending the high-frequency bandwidth of the audio signal using a non-blind bandwidth extension that operates on the audio signal based on the side information.

5. The method of claim 1, where the radio device comprises a portable radio device.

6. The method of claim 5, where the portable radio device comprises a cellular phone.

7. A radio device, comprising:
amplitude modulation (AM) circuitry that:
receives an amplitude modulation (AM) transmission that includes an audio signal, and
retrieves the audio signal from the amplitude modulation (AM) transmission; and
a high-frequency bandwidth-extension control that extends a high-frequency bandwidth of the audio signal.

8. The radio device of claim 7, where the amplitude modulation (AM) transmission includes a narrow frequency channel allocation.

9. The radio device of claim 7, where the high-frequency bandwidth-extension control extends the high-frequency bandwidth of the audio signal using a blind bandwidth extension operating on the audio signal.

10. The radio device of claim 7, where the amplitude modulation (AM) transmission includes the audio signal and side information about missing high frequency components of the audio signal; and
where the high-frequency bandwidth-extension control:
retrieves the side information, and
extends the high-frequency bandwidth of the audio signal using a non-blind bandwidth extension that operates on the audio signal based on the side information.

11. The radio device of claim 7, where the radio device comprises a portable radio device.

12. The radio device of claim 11, where the portable radio device comprises a cellular phone.

13. A computer-readable memory device that stores computer-executable instructions, comprising:
one or more instructions to receive an amplitude modulation (AM) transmission that includes an audio signal;
one or more instructions to retrieve the audio signal from the amplitude modulation (AM) transmission; and
one or more instructions to extend a high-frequency bandwidth of the audio signal to provide a high-fidelity audio signal.

14. A radio device, comprising:
amplitude modulation (AM) circuitry;
a high-frequency bandwidth-extension control; and
a computer-readable memory device that stores computer-executable instructions, comprising:
one or more instructions to instruct the amplitude modulation (AM) circuitry to receive an amplitude modulation (AM) transmission that includes an audio signal,
one or more instructions to instruct the amplitude modulation (AM) circuitry to retrieve the audio signal from the amplitude modulation (AM) transmission, and
one or more instructions to instruct the high-frequency bandwidth-extension control to extend a high-frequency bandwidth of the audio signal to provide a high-fidelity audio signal.
